(19) United States
(12) Patent Application Publication
(10) Pub. No.: US 2017/0087497 A1
(43) Pub. Date: Mar. 30, 2017

(54) INLET DISTRIBUTOR DEVICE AND METHODS FOR USE AND DESIGN THEREOF

(71) Applicant: Chevron U.S.A. Inc., San Ramon, CA (US)

(72) Inventors: Weldon Lee Ransbarger, Cypress, TX (US); Lee David Rhyne, Cypress, TX (US)

(21) Appl. No.: 14/869,319

(22) Filed: Sep. 29, 2015

(51) Int. Cl. B01D 46/00; C10L 3/10; G06F 17/50

(52) U.S. Cl. CPC B01D 46/0041; B01D 46/0031; G06F 17/50; C10L 3/106; C10L 2290/08

(57) ABSTRACT

Disclosed are an inlet distributor device and its use in a separation vessel for separating liquid and gas. The separation vessel also includes a mist elimination device for removing vapor droplets. The inlet distributor device includes a distributor body of a rigid material having a partially enclosed three-dimensional shape, a distributor inlet adapted to be fitted to the vessel inlet such that the distributor body is positioned internally within the vessel, and a mesh material within the volume of the distributor body. Also disclosed is a method for designing the inlet distributor device. A mesh file representing the separation vessel, the mist elimination device and the inlet distributor device is generated using estimated design parameters of the separation vessel and estimated coordinates defining the distributor body. A computational fluid dynamics software package is utilized to simulate fluid behavior of fluid flowing in and through the separation vessel and solve for fluid behavior based on known and estimated variables, operating conditions and mesh material parameters. The estimated design parameters and geometry of the inlet mesh distributor, estimated variables, operating conditions and/or mesh material parameters are modified as needed until the desired fluid behavior is obtained such that the mist elimination device in the separation vessel is not overloaded with liquid droplets and velocities in the mist elimination devices are within a design velocity range.

### FIELD

The present disclosure relates to a device for uniformly distributing liquid and vapor fluid mixtures being introduced into a separation vessel, and to methods for the design and use thereof.

### BACKGROUND

Gas treatment processes frequently include separation vessels for separating liquid from gas. A fluid feed including the liquid and gas is received by an inlet into the separation vessel whereupon the fluid conventionally encounters some type of inlet distributor device. For example, as shown in FIG. 1, an inlet vane distributor is frequently used in which multiple vanes are used which are designed to spread or proportion the incoming fluid flow along the perimeter of an inlet distributor device. Other designs of inlet distributor devices are known for use as well, including the use of diagonal plates, inlet deflectors, and inlet baffle distributors which cause the fluid to swirl upon passing through the device. Once the feed fluid has passed through the inlet distributor device, gas generally flows upward and liquid flows downward in the separation vessel. The upward flowing gas carries liquid droplets which are conventionally captured by one or more mist elimination device(s) located above the inlet distributor device in the separation vessel. Despite advances in inlet distributor device design, fluid flow leaving such devices is frequently quite nonuniform, in terms of spatial and velocity distribution and the distribution of liquid droplets throughout the fluid leaving the inlet distributor device. Such non-uniformly distributed liquid droplets then are captured by the mist elimination device, which can cause overloading of the mist elimination device, leading to liquid transport in a supposedly gas-only flow line. Such liquid carryover can cause downstream equipment failure. Mitigation of liquid carryover most often results in reduced flow rates through the separator thereby negatively impacting the throughput, plant capacity, and plant economics.

It would be desirable to have a way to more uniformly distribute, both in terms of spatial distribution and velocity distribution, a fluid including a gas in a separation vessel to avoid the aforementioned difficulties. It would further be desirable to provide a more uniform distribution of gas and fine liquid droplets to the mist elimination device(s). It would further be desirable to ensure a gentler treatment of liquid droplets to prevent droplets being shattered into very small droplets that are much more difficult to separate. It would further be desirable to have a means for agglomerating small droplets to improve the separation performance of the entire vessel.

### SUMMARY

In one aspect, a method is provided for designing an inlet distributor device for use in a separation vessel for separating liquid and gas utilizing a mist elimination device. The separation vessel has a vessel wall and a vessel inlet through which fluid is introduced into the separation vessel from a fluid source. A mesh file generation software package is utilized to generate a mesh file representing the separation vessel, the mist elimination device and the inlet distributor device, as well as any other devices present in the vessel that can affect the fluid flow. Estimated design parameters of the separation vessel and estimated coordinates defining a three-dimensional shape of a distributor body are input into the mesh file generation software package. A computational fluid dynamics software package is utilized to simulate fluid behavior of fluid flowing in and through the separation vessel and solve for fluid behavior based on known and estimated variables, operating conditions and mesh material parameters. The estimated design parameters, estimated variables, operating conditions and/or mesh material parameters are modified as needed until the desired fluid behavior is obtained such that the mist elimination device in the separation vessel is not overloaded with liquid droplets and velocities in the mist elimination devices are within a design velocity range. The design parameters, variables, operating conditions and mesh material parameters yielding the desired fluid behavior are utilized as the basis for design of the inlet distributor device.

In another aspect, an inlet distributor device is provided for use in a separation vessel for separating liquid and gas utilizing a mist elimination device wherein the separation vessel has a vessel wall and a vessel inlet through which fluid is introduced into the separation vessel from a fluid source. The inlet distributor device has a distributor body of a rigid material having a partially enclosed three-dimensional shape, a distributor inlet is adapted to be fitted to the vessel inlet such that the distributor body is positioned internally within the vessel wall and a mesh material within the volume of the distributor body.

In another aspect, a method is provided for separating a fluid into liquid and gas components in a separation vessel utilizing the inlet distributor device and a mist elimination device. The separation vessel has a vessel wall and a vessel inlet through which the fluid is introduced into the separation vessel from a fluid source. The distributor inlet of the inlet distributor device is fitted to the vessel inlet. The distributor body of the inlet distributor device is positioned internally within the vessel. The mist elimination device is positioned internally within the vessel at a vertical position above the distributor body of the inlet distributor device. The method includes feeding the fluid comprising vapor and liquid into the vessel inlet such that the fluid flows through the mesh material of the inlet distributor device and then into the separation vessel. The gas component is removed from a gas outlet in the vessel wall located above the mist elimination device such that fluid flows through the mist elimination device before being removed from the gas outlet as the gas component, and the liquid component is removed from a liquid outlet in the vessel wall.

### DESCRIPTION OF THE DRAWINGS

These and other objects, features and advantages of the present invention will become better understood with reference to the following description, appended claims and accompanying drawings where:

FIG. 1 is a perspective view illustrating an inlet vane distributor according to the prior art.

FIG. 2 is a perspective view illustrating an inlet distributor device in a separation vessel according to one exemplary embodiment.

FIGS. 3 and 4 are graphical simulation results illustrating velocity contours according to the prior art and an exemplary embodiment, respectively.

### DETAILED DESCRIPTION

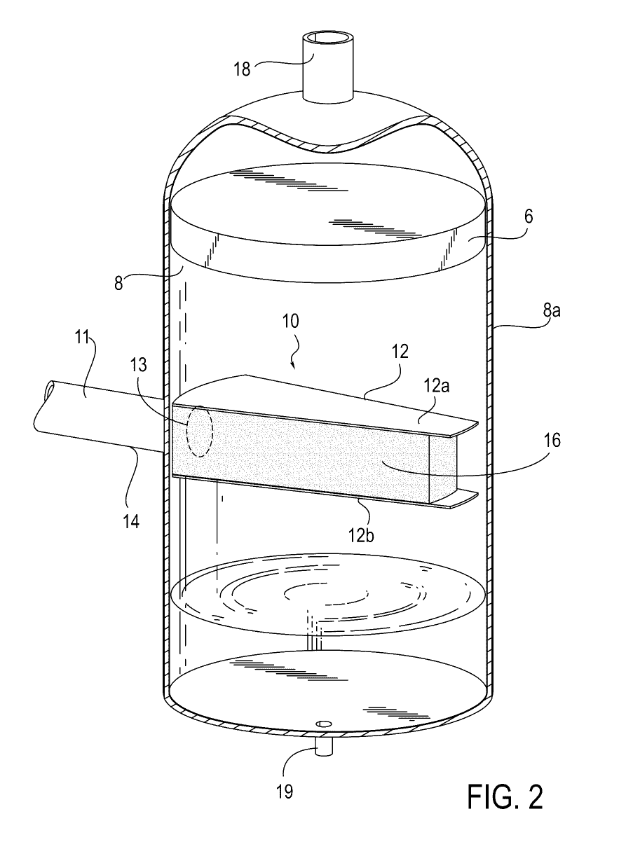

In one embodiment, as illustrated in FIG. 2, an inlet distributor device 10, also referred to herein as an inlet mesh distributor 10, is provided for use in a separation vessel 8 for separating liquid and gas. The separation vessel 8 utilizes one or more mist elimination device(s) 6, such that the mist elimination device(s) 6 is positioned internally within the separation vessel 8 for removing fine mist from the fluid. The separation vessel 8 has a vessel wall 8a and a vessel inlet 14 in the form of an opening in the vessel wall through which fluid is introduced into the separation vessel 8 from a fluid conduit 11 from an external fluid source (not shown).

The inlet distributor device 10 has a distributor body 12 having a partially enclosed three-dimensional shape. The distributor body 12 is formed of any suitable rigid material. A distributor inlet 13 is adapted to be fitted to the vessel inlet 14 such that the distributor body 12 is positioned internally within the vessel wall 8a. The inlet distributor device 10 includes a mesh material 16 within the volume of the distributor body 12. In one embodiment, the mesh material 16 substantially fills the volume of the distributor body 12. In one embodiment, the mesh material 16 can be formed of metallic wire, glass fiber, and/or polymeric fiber. In one embodiment, the mesh material 16 has nonuniform density and/or porosity. For instance, the mesh material can be a combination of materials having differing properties. In one embodiment, the mesh material can be in the form of knitted material, nonwoven material, and/or woven material. In one nonlimiting example, the mesh material includes both metal and polytetrafluoroethylene fibers woven side-by-side. The mesh material can be any suitable material that can be wetted by the liquid, withstand the anticipated stresses during use and be chemically compatible with the fluid.

In one embodiment, the distributor body 12 can have any of a variety of partially enclosed three-dimensional shapes, including, but not limited to, a wedge shape (as shown), a cone shape, a rectangular block shape, a circular cylinder shape, a shape that is a portion of a wedge, a cone, a rectangular block or a circular cylinder, and combinations thereof The partially enclosed three-dimensional shape can be a hollow shape. The distributor body 12 must be partially enclosed in order to allow fluid to flow therethrough. Therefore, openings must be provided in at least a portion of the top, bottom and/or sides of the distributor body. In one embodiment, the partially enclosed three-dimensional shape has an upper surface 12a and a lower surface 12b and each of the upper and the lower surfaces has a solid surface or an exposed surface of the mesh material 16.

The distributor body 12 can be designed to cover either a portion of a cross-section of the vessel or an entire cross-section of the vessel 8. Thus, the distributor 10 in use may extend either fully or partially across the vessel 8 from the inlet 13 to the opposite side of the vessel. At the distributor inlet 13, i.e., where the distributor inlet 13 is fitted to the vessel inlet 14, the distributor body 12 has a minimum dimension being the diameter of the opening of the distributor inlet 13. The distributor 10 can extend horizontally to a variable extent as needed to achieve the desired distribution of incoming fluid. The vertical dimension of the distributor 10 can also be varied to improve distribution of the fluid throughout the vessel 8.

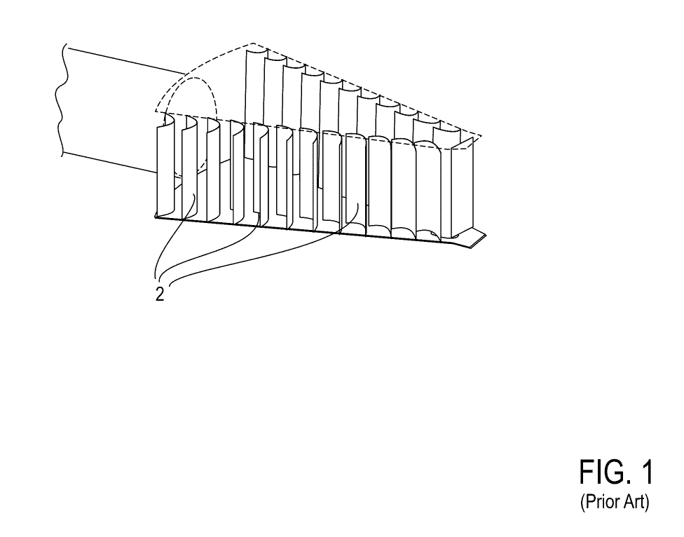

The distributor body 12 can include optional vanes as used in the prior art inlet distributor devices and as shown in FIG. 1, in addition to the mesh material 6.

In one embodiment, a method is provided for designing the inlet distributor device 10. A mesh file generation software package is utilized to generate a mesh file. Estimated design parameters of the separation vessel and estimated coordinates defining a three-dimensional shape of a distributor body are input into the mesh file generation software package. In one embodiment, the estimated design parameters of the separation vessel are selected from the group consisting of vessel diameter, vessel height, vessel internal components, diameter of the opening in the vessel wall and combinations thereof The required information for designing the distributor body 12 are the estimated x,y,z coordinates to define the three-dimensional shape of the distributor body. The mesh generation software is run to generate a mesh file representing the separation vessel, the mist elimination device and the inlet distributor device. The mesh could be generated by any gridding package. An example of a gridding package is GAMBIT (available from ANSYS Inc., Canonsburg, Pa.).

A computational fluid dynamics (CFD) software package is then utilized to simulate fluid behavior of fluid flowing in and through the separation vessel and solve for fluid behavior based on known and estimated variables, operating conditions and mesh material parameters. In one embodiment, the fluid behavior is selected from the group consisting of fluid velocity, fluid mass flow rate, fluid momentum, fluid temperature and distributions and combinations thereof. An example of CFD software package is ANSYS Fluent software (available from ANSYS Inc., Canonsburg, Pa.).

In one embodiment, the known variables characterizing the fluids being introduced into the separation vessel, i.e., the gas and liquid droplets, from the fluid source external to the separation vessel are selected from the fluid velocities, fluid densities, fluid viscosities and combinations thereof This known information is input as assumptions into the CFD software package.

In one embodiment, the estimated vessel operating conditions are selected from the group consisting of liquid level height, liquid loading in incoming stream, droplet size distribution in the incoming stream, liquid distribution split between mist and film and combinations thereof The estimated operating conditions are input as initial assumptions into the CFD software package.

In one embodiment, the estimated mesh material parameters are selected from the group consisting of porosity, resistance factor and combinations thereof The estimated mesh material parameters are input as initial assumptions into the CFD software package. The mesh is simulated as a porous media. It has a porosity and resistance factors that are user specified. In one nonlimiting example, the porosity is specified as 98%. The code can use the Ergun equation for porous media. Resistance factor is a mesh material parameter representing the effects of drag on the fluids and pressure drop. The resistance factors can be adjusted for different meshes. For example, larger resistance factors are used for tighter weave mesh materials. The resistance factor is specified as a resistance per linear foot. The resistance factors are calculated based on manufacturer specifications for the particular mesh. The resistance factors can vary through the mesh body to represent variations in the properties of the mesh in different locations. The resistance factors can vary in different spatial directions to model preferential flow directions induced by the mesh construction.

The CFD software is run to solve for simulated fluid behavior with the above assumptions, both known information and estimates, using the mesh file generated by the mesh generation software. Resulting fluid velocity, fluid mass flow rate, fluid momentum, fluid temperature, droplet trajectories and distributions and combinations thereof are obtained from the CFD software and can be analyzed. An operator or engineer reviewing the results will assess whether the results are a desired fluid behavior, in which fluid is distributed more uniformly and gently than without the use of the inlet mesh distributor. The desired fluid behavior using the inlet mesh distributor can be characterized by absence of induced transients in the flow pattern, fluid flow momentum being partially absorbed, more uniform gas and droplet distributions (as compared with systems using inlet distributors not including the mesh material), much more uniform velocity distribution and low shear flow.

The operator or engineer can then make changes to the estimated assumptions based on judgment, experience or trial and error. The estimated variables, operating conditions and mesh material parameters are modified as needed until the desired fluid behavior is obtained such that the mist elimination device in the separation vessel is not overloaded with liquid droplets and velocities in the mist elimination devices are within a design velocity range. The variables, operating conditions and mesh material parameters yielding the desired fluid behavior are utilized as the basis for design of the inlet distributor device. The ideal basis of design for the inlet mesh distributor is a perfectly uniform velocity field. This is likely never achievable, however, iterations are made until the solution is considered sufficiently improved. This can be determined by checking if the mist elimination device(s) above the inlet mesh distributor are evenly distributed, not overloaded with liquid droplets, and the velocities in those device(s) are within their intended operational velocity range. The velocities on the surface of separated liquid can also be checked to ensure they are sufficiently low to prevent re-entrainment of the separated liquid as droplets.

In another aspect, a method is provided for separating a fluid into liquid and gas components in the separation vessel 8 utilizing the inlet distributor device 10 and mist elimination device 6. Preferably, the fluid containing vapor and liquid is free of solid particles or solid-forming contamination, i.e. sand, scale, wax, asphaltenes, etc. The distributor inlet 13 of the inlet distributor device is fitted to the vessel inlet 14. The distributor body 12 of the inlet distributor device is positioned internally within the vessel 8. The mist elimination device 6 is positioned internally within the vessel 8 at a vertical position above the distributor body 12 of the inlet distributor device. The method includes feeding the fluid comprising vapor and liquid into the vessel inlet such that the fluid flows through the mesh material 16 of the inlet distributor device 10 and then into the separation vessel 8. The gas component is removed from a gas outlet 18 in the vessel wall 8a located above the mist elimination device 6 such that fluid flows through the mist elimination device 6 before being removed from the gas outlet 18 as the gas component, and the liquid component is removed from a liquid outlet 19 in the vessel wall.

Methods according to the present disclosure are useful in low interfacial tension (IFT) and low-density ratio separations. Low interfacial tension liquids, such as propane refrigerant, are generally difficult to separate. In one embodiment, the separation vessel 8 utilizing the inlet distributor device 10 is a component of a propane refrigeration loop. Low-density ratio separations, in which the density of the gas approaches the density of the liquid, are also difficult.

In one embodiment, the fluid containing vapor and liquid fed into the vessel inlet 14 is natural gas to be partially dehydrated in the separation vessel 8. A separation vessel 8 using the inlet distributor device 10 is useful for processing feed gas for liquefied natural gas (LNG), liquefied petroleum gas (LPG), natural gas liquids (NGL) processes and other natural gas treating processes.

In one embodiment, the separation vessel 8 utilizing the inlet distributor device 10 is a compressor scrubber to remove liquid from a gas prior to compression. In another embodiment, the separation vessel 8 utilizing the inlet distributor is 10 is a reflux drum.

Use of the inlet distributor device 10 advantageously results in more even distribution of fluid leaving the inlet distributor device 10, in terms of both spatial distribution and velocity distribution. Lower shear is encountered by the droplets, thus reducing the risk of breaking droplets. Having fewer broken droplets enables more complete capture of the liquid droplets. Swirling motion of the fluid feed is reduced by passing through the inlet distributor device 10. Reduction in swirling motion is advantageous because it allows the separator vessel 8 to have a shorter length of inlet piping 11 than is normally ideal and this allows the separator vessel to be placed more closely to other equipment, thereby reducing space requirements. A more uniform distribution of gas and droplets is provided to the mist elimination device 6.

Use of the inlet distributor device 10 also advantageously results in acceptable velocities on the surface of the separated liquid in the vessel 8. By “acceptable velocities” is meant that the velocities on the surface of the bulk separated liquid are not sufficient to entrain liquid from the surface of the bulk separated liquid as droplets. Unacceptable velocities caused by fluid force from the inlet distributor device 10 on the separated liquid can entrain liquid from the surface of the bulk separated liquid as droplets that can then add to the mist loading on the upper mesh pad.

Because of the advantages of the present methods, the separation vessel 8 can be smaller, since less three-dimensional space is required to achieve the desired fluid behavior. Similarly, use of the present methods can enable increased fluid flow capacity through existing separation vessel 8 in the context of a facility expansion. It should be noted that only the components relevant to the disclosure are shown in the figures, and that many other components normally part of the systems described are not shown for simplicity.

### EXAMPLE

Two separation vessels 8 for separating liquid and gas were modeled. One vessel was modeled as shown in FIG. 2, including a mist elimination device 6 and an inlet distributor device 10 according to the invention having a mesh material 16 within the distributor body 12. A comparative vessel was modeled to include a mist elimination device and an inlet vane distributor device according to the prior art as shown in FIG. 1. The separation vessels were otherwise identical.

GAMBIT mesh generation software (available from ANSYS Inc., Canonsburg, Pa.) was used to create mesh files for the example vessel and the comparative vessel. The mesh files include XYZ coordinates defining the corners of each cell of the mesh, thus defining the geometry of the vessels and all of the physical components therein.

For both the example vessel and the comparative vessel, the mesh files were input (also referred to as read into) into ANSYS Fluent computational fluid dynamics (CFD) software Release 16.2 (available from ANSYS Inc., Canonsburg, Pa.). Initial assumptions were input into the software. Transient flow was assumed. The viscous model chosen was k-omega (SST), thus defining the turbulence. The other models were turned off The materials were defined as gas as the fluid (gas and hydrocarbon). The material of the mist elimination device 6 was defined in the “porous zone” as having zero viscous resistance, an inertial resistance of about 508 m⁻¹ and a fluid porosity constant of 0.98.

In the CFD software, the operating conditions were input. Pressure was assumed to be 200 psig, and temperature was assumed to be 22.5° C. Relative pressure at the outlet was assumed to be zero. The gas density was assumed to be 15 kg/m³. Gas viscosity was assumed to be 0.012 cP. Gas flow rate was assumed to be 27.5 MMSCF per day. The liquid in the fluid was assumed to have a density of 63 kg/m³. The viscosity of the fluid was assumed to be 0.25 cP. Interfacial tension (IFT) was assumed to be 0.014 N/m. The liquid flow rate was assumed to be 0.435 kg per second. Again it should be noted that the conditions chosen here are nonlimiting examples, and are provided to illustrate the process of the invention.

As a boundary condition, the inlet velocity normal to the boundary was assumed to be 18.25 m/s.

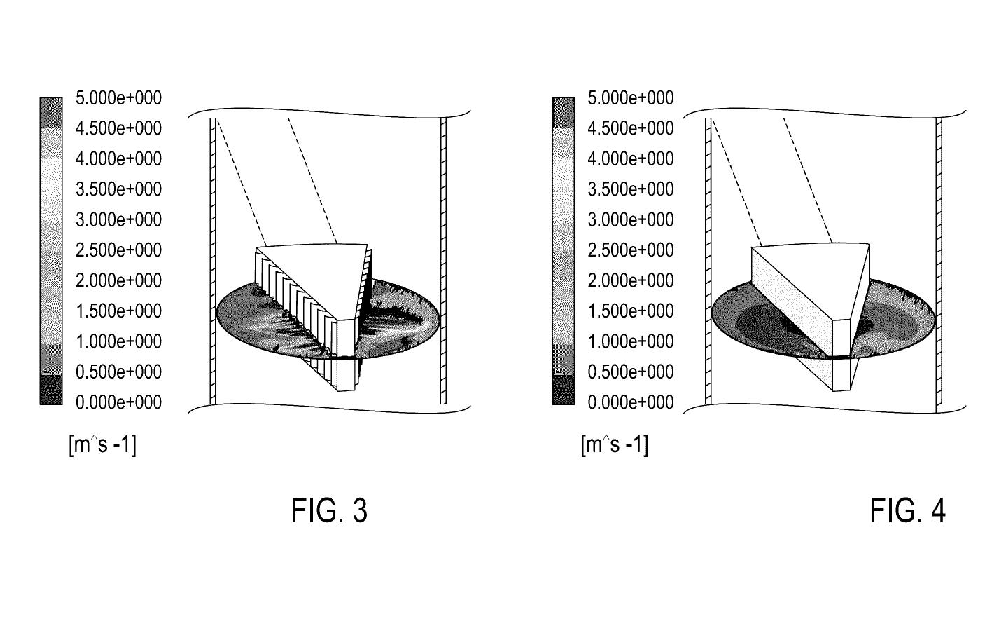

For the example vessel, the mesh material 16 used in the inlet distributor device 10 was also defined in the “porous zone” as having zero viscous resistance, an inertial resistance of about 508 m¹ and a fluid porosity constant of 0.98. Note that this is a nonlimiting example, and other materials having other resistances and porosities could also be chosen. The CFD software was used to solve equations of motion for fluid flowing within each grid cell being modeled. The convergences were checked for consistency between the solutions of the multiple equations being solved. 0.001 was the convergence criteria used for continuity, momentum, and turbulence equations. Subsequently, the CFD software allowed fluid motions (i.e., u,v,w vectors) to be examined in a post-solution step. Note, the software allows fluid motions to be plotted on any specified or constructed surface as velocity contours, velocity vectors, and derivative functions such as vorticity, helicity, or shear stress. The velocity contours were plotted in a horizontal plane with the mesh made visible for both the example vessel and the comparative vessel, as seen in FIG. 4 and FIG. 3, respectively. It can be seen from the figures that the use of the inlet distributor device 10 of the invention results in much more uniform flow through the device and into the vessel as compared with the use of the inlet vane distributor of the prior art.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention. From the above description, those skilled in the art will perceive improvements, changes and modifications, which are intended to be covered by the appended claims.

What is claimed is:

1. A method for designing an inlet distributor device for use in a separation vessel for separating liquid and gas utilizing a mist elimination device wherein the separation vessel has a vessel wall and a vessel inlet comprising an opening in the vessel wall through which fluid is introduced into the separation vessel from a fluid source external to the separation vessel, the method comprising:
a. utilizing a mesh file generation software package to generate a mesh file representing the separation vessel, the mist elimination device and the inlet distributor device wherein:
i. estimated design parameters of the separation vessel are input into the mesh file generation software package; and
ii. estimated coordinates are input into the mesh file generation software package wherein the coordinates define a three-dimensional shape of a distributor body of the inlet distributor device wherein the distributor body has a volume;
b. utilizing a computational fluid dynamics software package to simulate fluid behavior of fluid flowing in and through the separation vessel wherein:
i. known variables characterizing the fluid being introduced into the separation vessel from the fluid source external to the separation vessel are input into the computational fluid dynamics software package;
ii. estimated vessel operating conditions are input into the computational fluid dynamics software package;
iii. estimated mesh material parameters characterizing a mesh material for filling the volume of the distributor body are input into the computational fluid dynamics software package;
iv. the computational fluid dynamics software package solves for fluid behavior; and
v. if a desired fluid behavior is not obtained, any of steps (a)(i) through (b)(iii) are repeated wherein the estimated design parameters, estimated vessel operating conditions, estimated coordinates and/or estimated mesh material parameters are modified and step (b)(iv) is repeated until the desired fluid behavior is obtained; and
c. utilizing the estimated design parameters, estimated vessel operating conditions, estimated coordinates and estimated mesh material parameters as determined in step (b)(v) to obtain the desired fluid behavior as the basis for design of the inlet distributor device;
wherein the desired flow behavior is such that the mist elimination device in the separation vessel is not overloaded with liquid droplets and velocities in the mist elimination devices are within a design velocity range.

2. The method of claim 1 wherein the desired flow behavior is such that acceptable velocities are present on a surface of separated liquid in the vessel.

3. The method of claim 1 wherein the fluid behavior is selected from the group consisting of fluid velocity, fluid mass flow rate, fluid momentum, fluid temperature and distributions and combinations thereof.

4. The method of claim 1 wherein the known variables characterizing the fluid being introduced into the separation vessel from the fluid source external to the separation vessel are selected from the group consisting of fluid velocity, fluid density, fluid viscosity and combinations thereof.

5. The method of claim 1 wherein the estimated design parameters of the separation vessel are selected from the group consisting of vessel diameter, vessel height, vessel internal components, diameter of the opening in the vessel wall and combinations thereof

6. The method of claim 1 wherein the estimated vessel operating conditions are selected from the group consisting of liquid level height, liquid loading in incoming stream, droplet size distribution in the incoming stream, liquid distribution split between mist and film and combinations thereof.

7. The method of claim 1 wherein the estimated mesh material parameters are selected from the group consisting of porosity, resistance factor and combinations thereof.

8. An inlet distributor device for use in a separation vessel for separating liquid and gas utilizing a mist elimination device wherein the separation vessel has a vessel wall and a vessel inlet comprising an opening in the vessel wall through which fluid is introduced into the separation vessel from a fluid source, the inlet distributor device comprising:
a. a distributor body comprising a rigid material having a partially enclosed three-dimensional shape such that the distributor body has a volume;
b. a distributor inlet adapted to be fitted to the vessel inlet such that the distributor body is positioned internally within the vessel wall; and
c. a mesh material within the volume of the distributor body.

9. The inlet distributor device of claim 8 wherein the mesh material comprises a material selected from the group consisting of metallic wire, glass fiber, polymeric fiber, and combinations thereof.

10. The inlet distributor device of claim 8 wherein the mesh material has nonuniform density and/or porosity.

11. The inlet distributor device of claim 8 wherein the mesh material is in the form of knitted material, nonwoven material, woven material and combinations thereof.

12. The inlet distributor device of claim 8 wherein the mesh material substantially fills the volume of the distributor body.

13. The inlet distributor device of claim 8 wherein the partially enclosed three-dimensional shape is selected from the group consisting of a wedge shape, a cone shape, a rectangular block shape, a circular cylinder shape, a shape that is a portion of a wedge, a cone, a rectangular block or a circular cylinder, and combinations thereof

14. The inlet distributor device of claim 13 wherein the partially enclosed three-dimensional shape is a hollow shape.

15. The inlet distributor device of claim 8 wherein the partially enclosed three-dimensional shape has an upper surface and a lower surface wherein each of the upper surface and the lower surface comprises a solid surface or a surface of the mesh material.

16. The inlet distributor device of claim 8 wherein the distributor body is adapted to cover either a portion of a cross-section of the vessel or an entire cross-section of the vessel.

17. A method for separating a fluid into liquid and gas components in a separation vessel utilizing the inlet distributor device of claim 8 and a mist elimination device; wherein:
the separation vessel has a vessel wall and a vessel inlet comprising an opening in the vessel wall through which the fluid is introduced into the separation vessel from a fluid source;
the distributor inlet of the inlet distributor device is fitted to the vessel inlet;
the distributor body of the inlet distributor device is positioned internally within the vessel; and
the mist elimination device is positioned internally within the vessel at a vertical position above the distributor body of the inlet distributor device; the method comprising:
a. feeding the fluid comprising vapor and liquid into the vessel inlet such that the fluid flows through the mesh material of the inlet distributor device and into the separation vessel;
b. removing the gas component from a gas outlet in the vessel wall located above the mist elimination device such that fluid flows through the mist elimination device before being removed from the gas outlet as the gas component; and
c. removing the liquid component from a liquid outlet in the vessel wall.

18. The method of claim 17, wherein the fluid comprising vapor and liquid fed into the vessel inlet is natural gas to be dehydrated in the separation vessel.

19. The method of claim 17, wherein the mist elimination device in the separation vessel is not overloaded with liquid droplets, velocities in the mist elimination devices are within a design velocity range, and acceptable velocities are present on a surface of separated liquid in the vessel.
